(19) United States
(12) Patent Application Publication
(10) Pub. No.: US 2007/0009712 A1
(43) Pub. Date: Jan. 11, 2007

(54) Force-introduction point in core composites and method for producing said point using reinforcement elements that traverse the thickness of the core composite

(75) Inventor: Matthias Alexander Roth, Griesheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Roehm Gbmh & Co. KG, Darmstadt (DE)

(21) Appl. No.: 10/569,271

(22) PCT Filed: Sep. 8, 2004
(86) PCT No.: PCT/EP04/10033

§ 371 Date: Feb. 23, 2006

(30) Foreign Application Priority Data
Sep. 8, 2003 (DE) 20314187.3
Sep. 8, 2003 (DE) 10342183.1

(51) Int. Cl. B32B 3/00

(52) U.S. Cl. 428/172; 428/223

(57) ABSTRACT

The invention relates to the configuration and production of force-introduction points in core composites using reinforcement elements that traverse the thickness of said core composite. The reinforcement elements that traverse the thickness of the core composite are provided in the vicinity of the force-introduction points. The reinforcement elements (e.g. stitched fibres) are preferably incorporated by means of a stitching process and a stitching needle. After the stitching process, the cover layers (a and c), which preferably consist of textile semi-finished products and the hole produced by the passage of the needle, together with the reinforcement element are impregnated with a liquid polymer matrix, creating the material union of the core material and the cover layers.

Force introduction point in core composites and method for producing said point using reinforcement elements that traverse the thickness of the core composite.

The invention relates to the configuration and production of force introduction points in core composites using reinforcement elements that traverse the thickness of said core composite according to the precharacterizing clause of claim 1.

The invention is suitable for introducing forces and torques into core composite structures. The core composite structure may preferably comprise a fiber-plastic composite with cover layers of textile semifinished products (1 and 3, for example woven or laid fabrics, mats, etc.), a core material (2, for example polymeric foam) and a polymeric matrix material (thermoplastic or thermosetting material). Core composites are structures that are built up layer by layer and comprise relatively thin upper cover layers (1) and lower cover layers (3) and also a relatively thick core layer (2) of low apparent density. On account of the comparatively thin cover layers and the core material with low tensile and compressive resistance, core composite structures are always sensitive to locally introduced forces or torque loads. Therefore, the introduction of force into core composite structures must be performed in a way appropriate for the stress conditions, the material and way they are produced. The multiaxial state of stress prevailing at the force introduction point can no longer be withstood by the cover layers, which are designed exclusively for membrane loads (tension, compression, shearing). The structural measures required as a result at the force introduction point depend on the location and direction of the forces and on the composition of the forces acting. The introduction of force must generally take place in such a way that no local instabilities occur (for example warping or crumpling of the cover layers), the core layer and the cover layers are not damaged and the force introduction element does not become detached from the core composite structure. This presupposes that the forces and torques introduced into the core composite structure are distributed over as large an area as possible and as uniformly as possible. Consequently, all the structural measures for introducing forces into sandwich structures share the common aspect that they bring about a reduction in the local level of stress by increasing the size of areas of force introduction and cross section. Furthermore, in some applications the core material of low compressive resistance must be replaced in the region of the force introduction point by a material of high compressive resistance, so that, for example, the prestressing forces of screw connections can be withstood.

For the introduction of forces and torques into core composites, additional applied force introduction elements (known as onserts) or incorporated force introduction elements (known as inserts) may be used. Furthermore, there is the possibility of removing the core material in the region of the force introduction point and bringing the two cover layers together, so that there is a monolithic region of fiber-plastic composite and no additional force introduction elements are required. It is also possible to use as further force introduction concepts for core composite structures self-tapping screws or screw inserts as well as rivet connections, which however can only transmit low forces or torques. Force introduction points are always necessary whenever forces and torques are to be introduced into a structure or removed from a structure and structural members are to be connected to one another. Core composite structures of fiber-plastic composite are often used for example in aerospace, rail and motor vehicle construction and in shipbuilding.

All known applied force introduction elements (onserts) for core composite structures of fiber-plastic composite are materially bonded onto one of the two cover layers. All solutions of this force introduction concept share the following disadvantages. The two cover layers are loaded very differently, i.e. the cover layer with the applied onsert is loaded much more than the opposite cover layer. This can cause delamination between the onsert and the cover layer or between the cover layers and the core layer. Furthermore, the core material of low tensile and compressive resistance underneath the onsert is not adequately reinforced, so that the core material is exposed to high loads and the core material can fail. In order to avoid failure of the core material underneath the onsert, in some solutions the core material is substituted completely in the region of the force introduction point by another material with higher mechanical properties.

All the known additionally incorporated force introduction elements (inserts) are materially bonded to the core composite structure. This allows the inserts to be placed within the cover layers, between the cover layer and the core layer or in the core material. On account of the purely material bond, the inserts may become detached from the entire core composite structure due to failure of the adhesive bond as a result of locally acting forces or torque loading, whereby total failure of the force introduction or delamination between the cover layers and the core layer can occur.

All known force introduction concepts for core composite structures without additional force introduction elements share the common aspect that, in the region of the force introduction point, the core material is first removed or compressed and the two cover layers are brought together, so that there is a monolithic region of individual reinforcement layers of fiber-plastic composite. Subsequently, a bolt connection can be provided in the monolithic region. With all the known solutions, this causes failure of the cover layers in the region where they are brought together or failure of the core or delamination between the cover layers and the core layer outside the region where the cover layers are brought together, since these regions do not have any additional nonpositive and positive reinforcement of the core composite structure in the direction of the thickness of the core composite structure.

The documents DE 100 02 281 A1 and EP 1 106 341 A2 disclose possibilities of a force introduction concept for core composite structures without an additional force introduction element involving bringing the cover layers together. In the case of these inventions, however, there is no nonpositive and positive reinforcement of the core composite structure inside or outside the region where the cover layers are brought together, so that neither the resistance to delamination (peel strength) between the cover layers and the core layer can be improved nor does the core layer have any reinforcement. Consequently, the typical failure behavior, delamination between the cover layers and the core layer and core failure in the region of the force introduction point, cannot be improved by these two disclosed possibilities.

The document US 005741574A discloses a possible way in which a bolt connection can be reinforced with the aid of a fiber reinforcing structure incorporated in the core. This invention is based on the initial incorporation of fiber filaments in the complete core material. Subsequently, the textile cover layers are applied to the core material and subjected to pressure, so that the core material is compressed and the filaments can penetrate into the cover layers. This is followed by impregnation of the core composite structure with a liquid thermosetting resin system. There then follows the curing process of the resin system. A through-hole for the bolt connection is introduced into the cured core composite structure. The fiber filaments in the core material are intended here to absorb the prestressing forces of the screw connection and prevent the tendency for delamination to occur between the cover layers and the core layer in the region of the force introduction point. In the case of this invention, in the region of force introduction there is only a material bond, and not a nonpositive and positive connection, between the fiber filaments and the entire core composite structure, whereby the resistance to delamination between the cover layers and the core layer is increased only slightly in comparison with a nonpositive and positive connection. A further disadvantage of this invention is that the complete core material of the core composite structure has stitching threads. As a result, the force introduction point does not undergo any necessary and additional reinforcement in comparison with the remaining core composite structure, so that the undisturbed core composite structure and the force introduction point are loaded very differently and the potential of core composite structures for lightweight construction is not fully exploited. Furthermore, the core material is open in the region of the through-hole, allowing liquid or gaseous media to penetrate into the core material. These penetrated media can adversely change the properties of the core material and even precipitate failure.

The document DE 198 34 772 C2 discloses a possible way of joining additionally inserted force introduction elements (inserts) with a fiber reinforcing structure comprising individual reinforcing layers. Here, the insert is placed between the individual reinforcing layers and stitched with the aid of stitching threads in the direction of the thickness of the fiber reinforcing structure. The disclosed solution for joining inserts in monolithic fiber reinforcing structures comprising individual reinforcing layers could also be used in the case of core composite structures. Here, the insert would be incorporated between the individual reinforcing layers of one of the two cover layers and stitched with the aid of stitching threads. Subsequently, both the cover layer including the stitched insert and the other cover layer would be applied to the core layer. With the aid of a liquid impregnating process, the cover layers could be impregnated with a polymeric matrix material and the adhesive bond between the cover layers and the core layer created, so that a core composite structure of fiber-plastic composite is obtained. Application of the disclosed invention to core composite structures would only bring about a nonpositive and positive connection between an insert and a cover layer created with the aid of stitching threads. This does not allow the resistance to delamination between the cover layers and the core layer to be increased or the core material of low tensile and compressive resistance to be reinforced in the region of the force introduction point, as a result of which neither of the two typical forms of failure of core composite structures can be improved. A further disadvantage of this invention is that, when forces and torques are introduced into the insert, the cover layer in which the insert is located is subjected to much greater stress than the other cover layer, whereby the potential of core composites for lightweight construction cannot be fully exploited. Furthermore, the flux of force from one cover layer to the other must take place via the core material, which has low mechanical properties in comparison with the material of the cover layers and represents the weak point in the core composite structure. This may have the effect that the core material is subjected to very high stress and core failures are precipitated. Consequently, the strength and rigidity of this point of force introduction or of the entire core composite structure are influenced primarily by the low mechanical properties of the core material.

All previously known force introduction concepts for core composite structures share the common aspect that the core composite structure is inadequately reinforced in the region of the force introduction point, whereby core failures can occur as a result of excessive tensile, compressive or shear stresses as well as delamination between the cover layers and the core layer. Furthermore, in the case of all known solutions of additionally applied or incorporated force introduction elements, there is no nonpositive and positive connection of the elements to the entire core composite structure. As a result, neither detachment of the force introduction element from the core composite structure nor delamination between the cover layers and the core layer or between the force introduction element and the cover layer can be prevented.

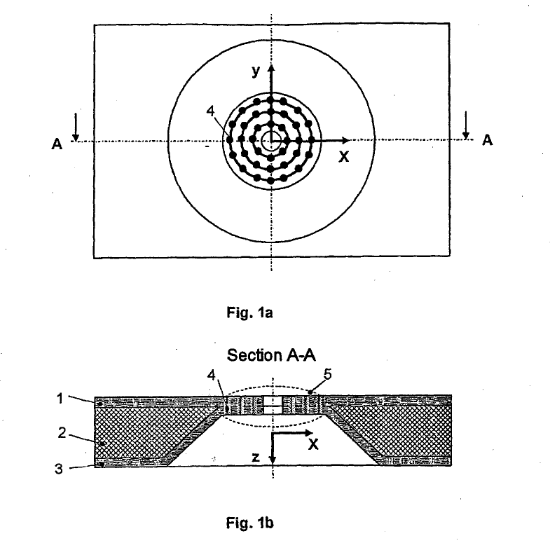

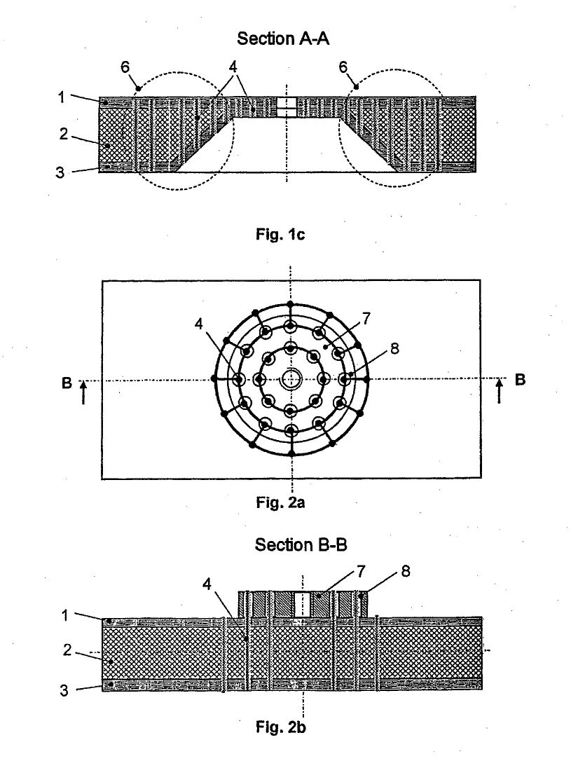

The invention is based on the object of improving the mechanical properties of the force introduction point in core composites by incorporating reinforcing elements in the direction of the thickness of the core composite structure (z direction) (FIGS. 1a and 1b).

This object is achieved by the cover layers of the core composite being brought together and/or a force introduction element arranged in the region of the force introduction point in core composites, and furthermore a reinforcement of the core composite structure by reinforcing elements that traverse the thickness of the core composite being provided at the introduction point. The reinforcing elements have the effect in the region of the force introduction point that the upper cover layer, the core layer and the lower cover layer are nonpositively and positively connected. Furthermore, the force introduction element may be fastened to the core composite with the aid of the reinforcing elements. Textile reinforcing structures (4, for example stitching threads, fiber strands, rovings, etc.) may preferably be used as reinforcing elements. This invention relates to core composites with cover layers (1 and 3), preferably of textile semifinished products (for example woven, laid or knitted fabrics, mats, etc.), and with a core layer (2), preferably of polymeric rigid foam, and if appropriate with a matrix material, preferably of polymeric material (thermoplastic or thermosetting material). The core composite structure may be produced in one of the numerous liquid composite molding (LCM) processes (for example resin injection or resin infiltration process). Core composite structures of this type are reinforced in the region of force introduction with the aid of a textile reinforcing structure in the direction of the thickness before the impregnation by the polymeric matrix material. The production of these reinforced force introduction points may take place for example by the industrial stitching technique. The incorporation of the reinforcing structure, preferably stitching threads, in the direction of the thickness of the core composite may take place for example by means of a stitching needle. The stitching needle thereby punctures the entire core composite structure and, in the case of a core material of polymeric rigid foam, leaves behind a through-hole, including the reinforcing structure. In this case, the cross-sectional area of the through-hole must be adequately large in comparison with the cross-sectional area of the reinforcing structure in order that the reinforcing structure can be impregnated with the polymeric matrix material and materially bonded to the core layer. The reinforcing elements may have an angle other than 0° in relation to the z axis within an xz or yz plane in the direction of the thickness of the core composite structure (FIGS. 1a and 1b), for example in the case of shear-dominant loading an angle of +/−45° between the x axis and z axis and/or between the y axis and z axis. After the force introduction point and the entire core composite structure have been completely reinforced with the reinforcing structure, the textile cover layers and the through-hole including the reinforcing structure are impregnated with the polymeric matrix material in an LCM process, the material bonding of the core material with the cover layers taking place at the same time. Once curing of the core composite structure has been completed, the textile reinforcing structure impregnated with the polymeric matrix material constitutes unidirectional, fiber-reinforced tension/compression bars within the core material, which bring about a reinforcement of the force introduction point, of the core material and of the entire core composite. The reinforcing structure has the task here of increasing the peel strength between the force introduction element and the core composite structure and between the cover layers and the core layer, of preventing detachment of the force introduction element from the core composite structure and of improving the mechanical properties of the core material (characteristic strength and rigidity values in the direction of the thickness). The textile reinforcing structure allows a crack that is present in the boundary region of the cover layer and core layer to be stopped or deflected. This allows the failsafe behavior of points of force introduction for core composites to be improved. The incorporation of a textile reinforcing structure in the direction of the thickness of the core composite structure in the region of the force introduction point allows the compressive and tensile strength perpendicular to the core composite plane, the compressive and tensile rigidity perpendicular to the core composite plane, the compressive strength in the core composite plane, the shear strength and rigidity and also the peel strength between the cover layers and the core layer and between the force introduction element and the cover layers to be increased in comparison with the known conventional force introduction concepts. Furthermore, the failure behavior can be improved by the increased peel strength and by the “crack stopping function” of the individual reinforcing elements, so that abrupt destruction of the force introduction can be prevented, and consequently what is known as failsafe behavior is obtained. With the aid of industrial stitching technology, the force introduction elements can be connected to the core composite structure in the correct positions. The incorporation and presence of a certain number of reinforcing elements allows the quality assurance of force introduction points in core composites to be ensured. A further advantage of this invention is that the reinforcing elements can reach beyond the force introduction point into the core composite structure surrounding the force introduction point, whereby higher forces and torques can be introduced into the core composite structure.

In order not to require any additional force introduction elements, which adversely influence the weight of the core composite structure, the core material may be removed or compressed in the region of the force introduction point, making it possible for the cover layers to be brought together. A further advantage can be accomplished by the force introduction element having one or more flanges, whereby the forces and torques can be introduced into the core composite structure over a larger surface area.

In order that the force introduction element can be nonpositively and positively connected to the entire core composite structure in the region of the force introduction point, the force introduction element has holes for receiving the reinforcing elements. This allows detachment of the force introduction element to be prevented and the peel strength between the force introduction element and the core composite structure to be increased. If the penetration of at least one cover layer of the core composite must be avoided on account of the technical requirements imposed on the core composite structural member (for example a ship's hull in shipbuilding), the force introduction element (so-called onsert) may be arranged on one of the two cover layers or on both cover layers.

In order to allow higher forces and torques to be introduced into the core composite structure, the force introduction element (so-called insert) may also be arranged within one of the two cover layers or within both cover layers. Furthermore, the force introduction element may be placed between the two cover layers, whereby the core material is traversed partly or completely.

A further advantage can be achieved by the application-related geometrical and structural configuration of the force introduction element, in that the force introduction element has one or more attachments lying against the cover layer or against the cover layers, whereby the introduction of the forces and torques can be improved as result of the greater lever arm.

With this invention there is the possibility of reinforcement for a kind of force introduction point in core composites by providing that, in the region of the force introduction point, the core material is removed or compressed and the two cover layers are brought together, so that there is a monolithic region of fiber-plastic composite. In this way, the upper cover layer (1) is connected to the lower cover layer (3) in the region of the force introduction point (5) by reinforcing elements (4) that traverse the thickness of the core composite structure, incorporated with the aid of a stitching technique (FIGS. 1a and 1b). Furthermore, the reinforcing elements (4) may reach beyond the force introduction point (6) into the core composite structure surrounding the force introduction point, in order to absorb higher forces and torques and improve the mechanical properties (FIG. 1c). The reinforced point of force introduction, without a force introduction element, for core composites with cover layers of textile semifinished products (1 and 3), a core material (2) and polymeric matrix material may be produced in one of the numerous LCM processes. In a working step preceding the incorporation of the polymeric matrix material, firstly the core material is removed or compressed in the region of the force introduction point. Subsequently, the two cover layers are brought together and the upper cover layer (1), the core material (2) and the lower cover layer (3) in the region of the force introduction (5), and if appropriate beyond (6), are stitched to one another by a textile reinforcing structure (4) in the direction of the thickness of the core composite structure with the aid of the stitching technique. After that, the core composite structure, including the textile reinforcing structure, is impregnated in an LCM process (for example resin injection or resin infiltration process) with a polymeric matrix material (thermosetting or thermoplastic material) and cured.

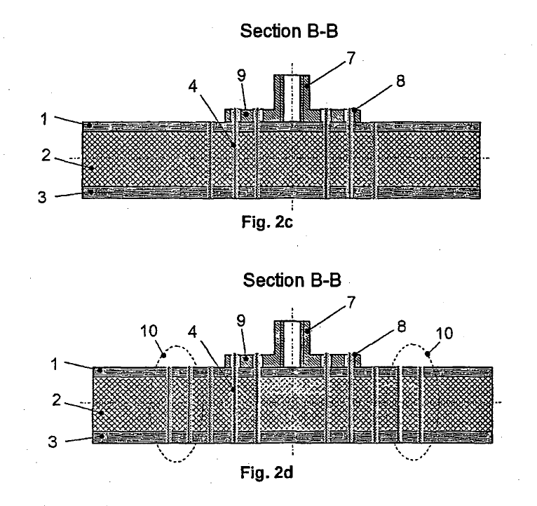

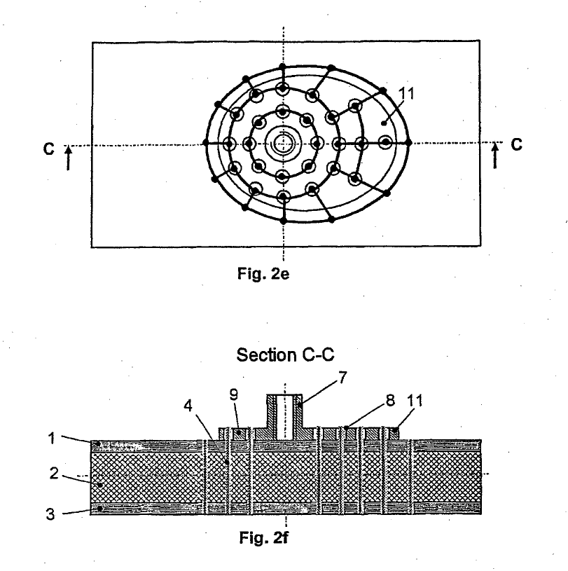

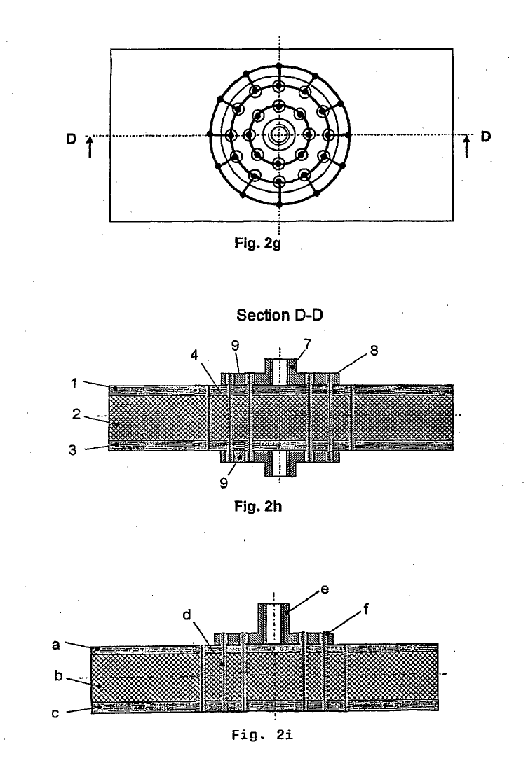

For the introduction of forces and torques, it is also possible to use a force introduction element (onsert, 7) applied to the core composite structure (FIGS. 2a and 2b). The onsert is applied to one of the two cover layers (FIGS. 2a to 2f) or to both cover layers (FIG. 2g) and connected to the entire core composite structure in the region of the force introduction point with the aid of reinforcing elements (4) in the direction of the thickness of the core composite structure. To receive the reinforcing elements, the onsert has holes (8). The onsert may have a laterally protruding flange (9) (FIG. 2c), which is arranged on the upper cover layer (1) or the lower cover layer (3), and likewise has holes (8) for receiving the reinforcing elements. For better introduction of the forces and torques, the reinforcing elements (4) may be incorporated in the core composite structure beyond (10) the onsert or the flange of the onsert in the direction of the thickness of the core composite structure (FIG. 2d). Furthermore, for better force and torque introduction into the core composite structure, the flange of the onsert may have one or more attachments (11) (FIGS. 2e and 2f). In a working step preceding the incorporation of the polymeric matrix material, the onsert (7) and the core composite structure in the region of the force introduction point are stitched to one another by a textile reinforcing structure (4) in the direction of the thickness of the core composite structure with the aid of an industrial stitching technique. This is followed by the impregnation and curing of the cover layers, the core layer and the textile reinforcing structure with a polymeric material in an LCM process.

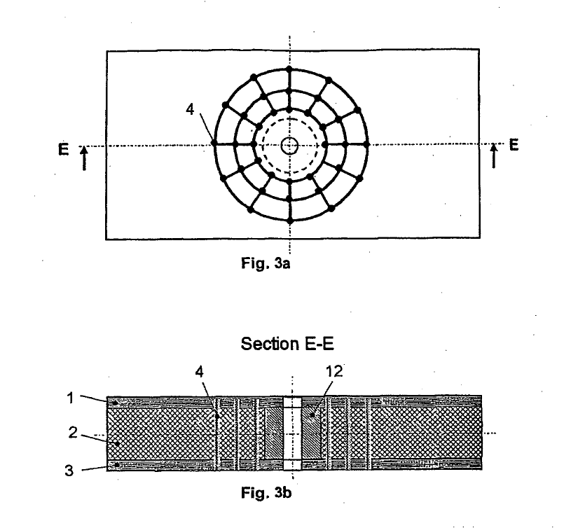

Force introduction points with a force introduction element (insert, 12) incorporated in the core composite structure can be reinforced by the upper cover layer (1), the core material (2) and the lower cover layer (3) outside the region of the insert being stitched to one another by reinforcing elements (4) in the direction of the thickness of the core composite structure (FIGS. 3a and 3b). The method for producing force introduction points with an incorporated force introduction element (12) for core composites with cover layers of textile semifinished products (1 and 3), a core material (2) and polymeric matrix material provides that, in a working step preceding the incorporation of the polymeric matrix material, the upper cover layer (1), the core material (2) and the lower cover layer (3) outside the force introduction point are stitched to one another by a textile reinforcing structure (4) incorporated in the direction of the thickness of the core composite structure with the aid of a stitching technique. The incorporation of the reinforcing structure is followed by the impregnation and curing of the core composite structure with a polymeric material in one of the possible LCM processes.

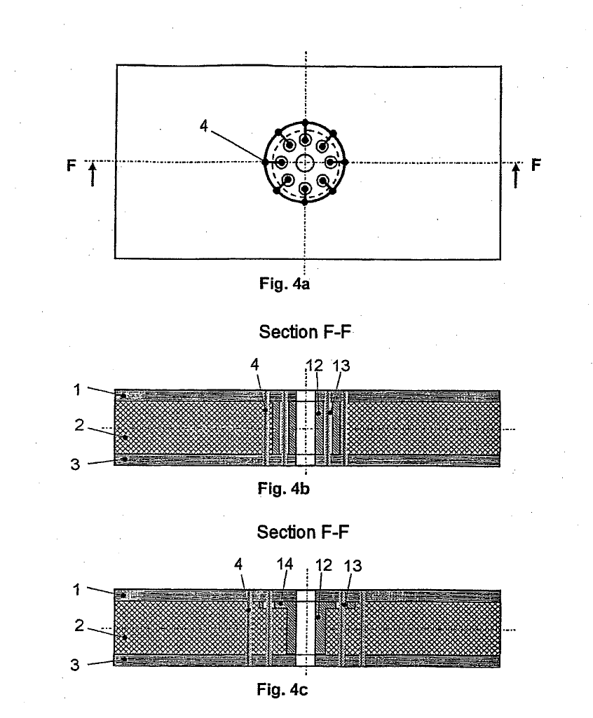

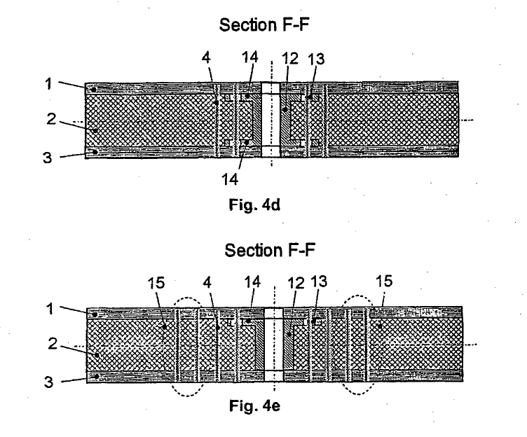

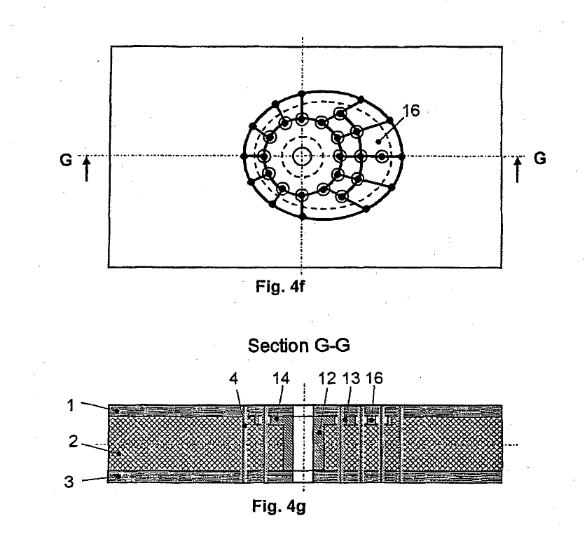

The insert (12) may also be connected to the core composite structure with the aid of reinforcing elements (4) in the direction of the thickness of the core composite structure (FIGS. 4a and 4b). For this purpose, the insert has holes (13) for receiving the reinforcing elements. Furthermore, the insert may have a (FIG. 4c) laterally protruding flange (14), which may be located within a cover layer (1 or 3), in the core layer. (2, FIG. 4c) or between the cover layer and the core layer, and has holes (13) for receiving a textile reinforcing structure. The insert may also have two laterally protruding and spaced-apart flanges (14) (FIG. 4d), which may be arranged within both cover layers (1 and 3), in the core layer (2, FIG. 4d) or between the cover layers (1 and 3) and the core layer (2), and have holes (13) for receiving the reinforcing elements. For better introduction of the forces and torques, the reinforcing elements (4) may be incorporated in the core composite structure beyond (15) the insert (12) or the flange (14) of the insert in the direction of the thickness of the core composite structure (FIG. 4e). For better force and torque introduction into the core composite structure, the flange of the insert may have one or more attachments (16) (FIGS. 4f and 4g). The method for producing force introduction points with incorporated force introduction elements (12) for core composites with cover layers of textile semifinished products (1 and 3), a core material (2) and polymeric matrix material provides that, in a working step preceding the incorporation of the polymeric matrix material, the inserts with the core composite structure are stitched with a textile reinforcing structure (4) incorporated in the direction of the thickness of the core composite structure with the aid of the stitching technique. The incorporation of the reinforcing structure is followed by the impregnation and curing of the core composite structure including the reinforcing structure and the insert with a polymeric material in an LCM process.

The invention is explained on the basis of 13 exemplary embodiments, in which:

FIG. 1a shows the view from below of a first exemplary embodiment with a force introduction point in core composites with cover layers (1 and 3) brought together, a core material (2) removed in the force introduction region and with reinforcing elements (4) that traverse the thickness of the core composite in the region of the force introduction point (5). FIG. 1b shows the sectional representation along line A-A of FIG. 1a.

FIG. 1c shows the sectional representation along line A-A of FIG. 1a with a second variant for the formation of the reinforcing elements, the reinforcing elements (4) reaching beyond (6) the force introduction point into the core composite structure surrounding the force introduction point.

FIG. 2a shows the plan view of a third exemplary embodiment with a force introduction element (7, onsert) placed on the upper cover layer (1) of the core composite structure, the onsert being connected to the entire core composite structure in the region of the force introduction point by reinforcing elements (4) in the direction of the thickness of the core composite structure and having holes (8) for receiving the reinforcing elements (4).

FIG. 2b shows the sectional representation along line B-B of FIG. 2a.

FIG. 2c shows the sectional representation along line B-B of FIG. 2a with a further variant for the configuration of the onsert, the onsert having a laterally protruding flange (9) (FIG. 2b), which is arranged on the upper cover layer (1), and likewise has holes (8) for receiving the reinforcing elements.

FIG. 2d shows the sectional representation along line B-B of FIG. 2a with a further variant for the formation of the reinforcing elements, the reinforcing elements (4) reaching beyond (10) the force introduction point into the core composite structure surrounding the force introduction point.

FIG. 2e shows the plan view of a sixth exemplary embodiment with a force introduction element (7, onsert) placed on the upper cover layer of the core composite structure, which element has an attachment (11) for better force and torque introduction into the core composite structure.

FIG. 2f shows the sectional representation along line C-C of FIG. 2e.

FIG. 2g shows the plan view of a seventh exemplary embodiment with two force introduction elements (7, onsert) placed on the upper cover layer (1) and lower cover layer (3) of the core composite structure, the two onserts being connected to the entire core composite structure in the region of the force introduction point by reinforcing elements (4) in the direction of the thickness of the core composite structure and having holes (8) for receiving the reinforcing elements (4).

FIG. 2h shows the sectional representation along line D-D of FIG. 2g.

FIG. 3a shows the plan view of an eighth exemplary embodiment with a force introduction element (12, insert) inserted in the core composite structure, the insert being arranged between the two cover layers (1 and 3) within the core material (2) of the core composite structure, and the upper cover layer (1), the core material (2) and the lower cover layer (3) being connected to one another outside the region of the insert by reinforcing elements (4) in the direction of the thickness of the core composite structure.

FIG. 3b shows the sectional representation along line E-E of FIG. 3a.

FIG. 4a shows the plan view of a ninth exemplary embodiment with a force introduction element (12, insert) inserted into the core composite structure, the insert being arranged between the two cover layers (1 and 3) within the core material (2) of the core composite structure, having holes (13) for receiving the reinforcing elements (4) and being connected to the core composite structure with the aid of the reinforcing elements in the direction of the thickness of the core composite structure.

FIG. 4b shows the sectional representation along line F-F of FIG. 4a.

FIG. 4c shows the sectional representation along line F-F of FIG. 4a with a further variant for the configuration of the insert, the insert having a laterally protruding flange (14), which lies against the upper cover layer (1), has holes (13) for receiving the reinforcing elements (4) and is connected to the core composite structure with the aid of the reinforcing elements in the direction of the thickness of the core composite structure.

FIG. 4d shows the sectional representation along line F-F of FIG. 4a with a further variant for the configuration of the insert, the insert having two laterally protruding flanges (14), which lie against the upper cover layer (1) and lower cover layer (3), have holes (13) for receiving the reinforcing elements (4) and are connected to the core composite structure with the aid of the reinforcing elements in the direction of the thickness of the core composite structure.

FIG. 4e shows the sectional representation along line F-F of FIG. 4a with a further variant for the formation of the reinforcing elements, the reinforcing elements (4) reaching beyond (15) the force introduction point into the core composite structure surrounding the force introduction point.

FIG. 4f shows the plan view of a thirteenth exemplary embodiment with a force introduction element (12, insert) inserted in the core composite structure, the insert having a laterally protruding flange (14), which has an attachment (16) for better force and torque introduction into the core composite structure, lies against the upper cover layer (1), has holes (13) for receiving the reinforcing elements (4) and is connected to the core composite structure with the aid of the reinforcing elements in the direction of the thickness of the core composite structure.

FIG. 4g shows the sectional representation along line G-G of FIG. 4f.

1-14. (canceled)

15. A force introduction point in core composites, comprising one or more cover layers and/or a force introduction element arranged at the force introduction point, and with reinforcing elements, said reinforcing elements traversing the thickness of the core composite at the introduction point.

16. The force introduction point of claim 15 comprising said reinforcing elements reaching beyond the force introduction point into the core composite structure surrounding the force introduction point.

17. The force introduction point of claim 15, comprising said cover layers consisting essentially of textile semifinished products, said core layer selected from the group consisting essentially of polymeric, natural or structured core material and said reinforcing elements consisting essentially of a textile reinforcing structure, said cover layers, the core layer and the reinforcing elements embedded in a polymeric matrix material.

18. The force introduction point of claim 15, comprising said core material being removed or compressed in the region of the force introduction point.

19. The force introduction point of claim 15, wherein said force introduction element has one or more flanges.

20. The force introduction point of claim 15, wherein said force introduction element has holes for receiving said reinforcing elements and is connected to the core composite structure in the region of the force introduction point by said reinforcing elements in the direction of the thickness of said core composite structure.

21. The force introduction according to claim 1, wherein the force introduction element is arranged on one of the two cover layers or on both cover layers.

22. The force introduction point according to claim 15, wherein said force introduction element is arranged on or within both of the two cover layers.

23. The force introduction point according to claim 15, wherein said force introduction element is arranged between the two cover layers and/or traverses said core material.

24. The force introduction point of claim 15, wherein said force introduction element has one or more attachments lying against one or more cover layers.

25. A method for producing a force introduction point according to claim 15 comprising, in a working step preceding the incorporation of a polymeric matrix material, the core material is removed or compressed in the region of the force introduction point, said two cover layers are brought together and the upper cover layer, the core material and the lower cover layer in the region of the force introduction point and/or beyond are stitched together by textile reinforcing elements incorporated with the aid of a stitching technique in the direction of the thickness of the core composite structure.

26. The method according to claim 25 comprising in a working step preceding the incorporation of the polymeric matrix material, in the region of the force introduction point the force introduction elements and the core composite structure in the region of the force introduction are stitched to one another by textile reinforcing elements incorporated with the aid of a stitching technique in the direction of the thickness of the core composite structure.

27. The method for producing a force introduction point according to claim 25 comprising in a working step preceding the incorporation of the polymeric matrix material, in the region of the force introduction point the upper cover layer, the core layer and the lower cover layer outside the region of the force introduction element are stitched to one another by textile reinforcing elements incorporated with the aid of a stitching technique in the direction of the thickness of the core composite structure.

28. A process for the construction of spacecraft, aircraft, watercraft or land vehicle comprising the step of incorporating the force introduction point of claim 15.

29. A spacecraft, aircraft, watercraft or land vehicle in which the force introduction point of claim 15 is included in the vehicle structure.
